(19) United States
(12) Patent Application Publication
(10) Pub. No.: US 2022/0354086 A1
(43) Pub. Date: Nov. 10, 2022

(54) ELEVATED PET WASTE COLLECTION TRAINING PAD

(71) Applicant: FOUR PAWS PRODUCTS, LTD., Neptune City, NJ (US)

(72) Inventors: Glen S. AXELROD, Colts Neck, NJ (US); Ajay GAJRIA, Monmouth Junction, NJ (US); Diana M. ECHEVERRI, Beachwood, NJ (US)

(21) Appl. No.: 17/662,387

(22) Filed: May 6, 2022

Related U.S. Application Data
(60) Provisional application No. 63/201,652, filed on May 7, 2021.

(51) Int. Cl. A01K 1/015; B32B 5/16; B32B 29/00; B32B 27/32; B32B 27/10; B32B 3/02; B32B 5/02; B32B 29/02; B32B 29/04; B32B 27/12; B32B 27/14

(52) U.S. Cl. CPC A01K 1/0157; B32B 5/16; B32B 29/00; B32B 27/32; B32B 27/10; B32B 3/02; B32B 5/02; B32B 29/02; B32B 29/04; B32B 27/12; B32B 27/14; B32B 2307/7265; B32B 2307/72; B32B 2264/025; B32B 2264/303; B32B 2262/065; B32B 2264/065

(57) ABSTRACT

Pet waste collection training pads having one or more regions elevated from a surface upon which the pads are to be disposed. More specifically, the present disclosure discloses a pet waste collection training pad arrangeable on a selected surface, comprising at least one upper layer and at least one lower layer; the at least one upper layer containing absorbent; and the at least one lower layer including at least one pleat having a base, wherein the at least one pleat elevates a region of the pad relative to the base of the pleat when the pad is on the selected surface.

### CROSS-REFERENCE TO RELATED APPLICATIONS

This non-provisional patent application claims the benefit of the filing date of U.S. provisional patent application Ser. No. 63/201,652, filed May 7, 2021, the entire disclosure of which is incorporated herein by reference.

### FIELD

The present disclosure generally relates to pet waste collection training pads. More specifically, the present disclosure relates to pet waste collection training pads having one or more regions elevated from a surface upon which the pads are to be disposed.

### BACKGROUND

Pet owners often housetrain pets such that the pet does not defecate or urinate at an undesirable location within the owner's home. For example, dog owners often train their dog to go to the bathroom outside the owner's home. In some situations, however, a dog or other pet may not be able to go outside when it needs to use relieve itself. To address such situations, a pet owner may train their pet to urinate or defecate at a consistent location within their home. For example, a pet owner may train a dog or other animal to urinate/defecate on an absorbent pet waste collection training pad that is placed at a desired location in the home. Such pads are configured to protect underlying surfaces from urine and feces and are often configured such that the owner can easily clean up and dispose of them once they are soiled.

While pet waste collection training pads are widely utilized and can be effective, such pads are generally configured to lay substantially flat on an underlying surface such as a floor. When an animal uses such a pad, animal waste (particularly urine) is then absorbed by the pad and may then soak into selected layers of the pad in order to contain such waste and then be properly disposed by the owner. However, when pads lay relatively flush to a given surface, and in particular when such pads are saturated, condensation can be observed to form between the pad bottom and the floor leading to moisture build-up. Accordingly, there remains a need for a pet training pads that when disposed on a floor, will avoid condensation and the floor will remain relatively dry.

### SUMMARY

A pet waste collection training pad arrangeable on a selected surface, comprising at least one upper layer and at least one lower layer; the at least one upper layer containing absorbent; and the at least one lower layer including at least one pleat having a base, wherein the at least one pleat elevates a region of the pad relative to the base of the pleat when the pad is on the selected surface.

In at least one embodiment, the at least one lower layer comprises the bottom layer of the pad.

In at least one embodiment, the bottom layer includes a channel which extends adjacent a longitudinal length of the at least one pleat, wherein the channel provides an air gap between the bottom layer of the pad and the selected surface when the pad is on the selected surface.

In at least one embodiment, the bottom layer is a film layer.

In at least one embodiment, the at least one pleat elevates the region of the pad relative to the base of the pleat by a vertical height in a range of 0.05 mm to 2 mm.

In at least one embodiment, the at least one pleat elevates the region of the pad relative to the base of the pleat by a vertical height greater than or equal to 1 mm.

In at least one embodiment, the at least one pleat includes at least one fold of the lower layer, wherein the fold comprises a fold bend connecting an upper fold segment overlying a lower fold segment.

In at least one embodiment, the at least one pleat having the base further comprises a plurality of pleats each having the base, respectively; the region of the pad is between the pleats; and wherein each pleat of the plurality of pleats elevates the region of the pad between the pleats relative to the base of the pleats.

In at least one embodiment, each pleat of the plurality of pleats elevates the region of the pad between the pleats relative to the base of the pleats by a vertical height in a range of 0.05 mm to 2 mm.

In at least one embodiment, each pleat of the plurality of pleats elevates the region of the pad between the pleats relative to the base of the pleats by a vertical height greater than or equal to 1 mm.

In at least one embodiment, each pleat of the plurality of pleats includes at least one fold of the lower layer, wherein the fold comprises a fold bend connecting an upper fold segment overlying a lower fold segment.

In at least one embodiment, each pleat of the plurality of pleats includes at least first and second folds of the lower layer, wherein the second fold overlies the first fold.

In at least one embodiment, the first and second folds each comprise a fold bend connecting an upper fold segment overlying a lower fold segment, respectively.

In at least one embodiment, the upper fold segment of the first fold and the lower fold segment of the second fold is shared by the first and second folds.

In at least one embodiment, the at least one pleat having the base further comprises a plurality of pleats each having the base, respectively; a bridge is disposed between at least two pleats of the plurality of pleats, and wherein at least a portion of the bridge is elevated relative to a base of the at least two pleats.

In at least one embodiment, the bridge is elevated relative to a base of the at least two pleats by a vertical height in a range of 0.05 mm to 2 mm.

In at least one embodiment, the bridge is elevated relative to a base of the at least two pleats by a vertical height greater than or equal to 1 mm.

In at least one embodiment, the bridge is disposed between at least one fold of a first pleat of the two pleats and at least one fold of a second pleat of the two pleats.

In at least one embodiment, the first pleat and the second pleat each comprise a lower fold and an upper fold; and wherein the bridge connects the upper fold of the first pleat to the lower fold of the second pleat.

A pet waste collection training pad arrangeable on a selected surface, comprising: an upper layer including absorbent; and a bottom layer including a channel which extends adjacent a longitudinal length of at least one pleat in the bottom layer, wherein the channel provides an air gap between the bottom layer of the pad and the selected surface when the pad is disposed on the selected surface; wherein the channel has a vertical height relative to a base of the pleat in a range of 0.05 mm to 2 mm; wherein the channel has a width W₁ in the range of 5 mm to 30 mm and a length in the range of 250 mm to 1200 mm.

### BRIEF DESCRIPTION OF THE DRAWINGS

Features and advantages of various embodiments of the claimed subject matter will become apparent as the following Detailed Description proceeds, and upon reference to the Drawings, wherein like numerals designate like parts, and in which:

FIG. 1 illustrates one example of a pet training pad consistent with the present disclosure.

FIG. 2 illustrates one example of the layering of a pet training pad consistent with the present disclosure.

FIG. 3 illustrates a cross-sectional view of the bottom portion of the pad of FIG. 1 along line A-A.

FIG. 4 provides a perspective view of the bottom portion of the pad where the upper layers have been eliminated, so that the spacing of the channels can be observed.

### DETAILED DESCRIPTION

As noted in the background, pet waste collection training pads are currently in widespread use. Although such pads can be effective, they typically are configured to lie flat on an underlying surface such as a floor. When an animal uses the pad, it may position itself so that urine and feces are deposited on the pad. When the bottom of the pad lies in direct contact with the floor, condensation may form between the pad bottom and the floor leading to moisture build-up.

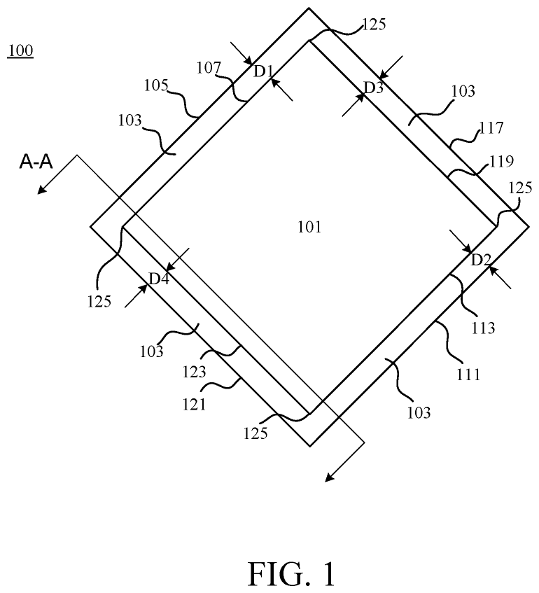

Attention is directed to FIG. 1, which illustrates one example of a pet waste collection training pad consistent with the present disclosure. Pad 100 may be initially provided in, or unfolded to, a substantially flat state, as shown in FIG. 1, which is a top (plan) view thereof. Pad 100 preferably includes an absorbent layer region 101 and a border region 103. The absorbent layer region 101 is generally configured to absorb or other retain animal waste, such as urine or feces. The nature and construction of absorbent layer region 101 is not limited, and absorbent layer region 101 may be constructed in any suitable manner. In embodiments, absorbent layer region 101 preferably includes at least one material layer that is configured to absorb liquid such as urine. In embodiments, the absorbent layer region 101 preferably includes a super absorbent polymer (SAP) layer, either alone or in combination with one or more material layers. For example, in embodiments the absorbent layer region 101 may include an attractant layer designed to attract an animal via an odor or other stimulant, a super absorbent polymer layer, and an odor control layer to mask/cover up odors. Such preferred additional layers may be provided on a fluid impervious backing layer and in any suitable order.

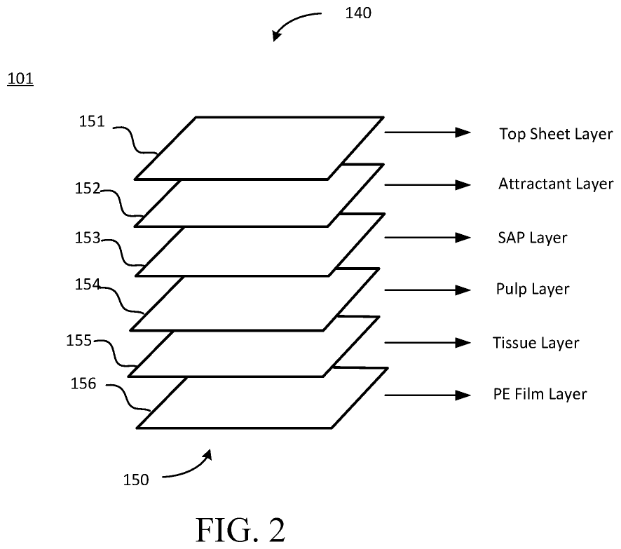

For example and as illustrated in FIG. 2, absorbent layer region 101 may include a top (sheet) layer 151 that is designed to be porous to liquid waste. This may then be followed by an attractant layer 152 which is designed to attract the animal via smell or another stimulant, and a super absorbent polymer (SAP) layer 153. It should also be appreciated that, optionally, additional layers may be present, such as an odor control layer or a scent layer which would mask or cover-up odors occurring after use.

The superabsorbent polymer 153 may preferably have, for example, a retention absorbency in a range of 30 g/g to 45 g/g, an absorption capacity in a range of 55 g/g to 65 g/g (as measured in a 0.% NaCl aqueous solution), an absorptive rate (e.g., a quantity of time to absorb 50, 100, or 150 milliliters of liquid such as a 0.9% NaCl aqueous solution) in a range of 15 seconds to 40 seconds, a moisture content in a range of 4% to 9%, a measure of residual acrylic acid monomers in a range of 15 parts-per-million (ppm) to 25 ppm, and a bulk density in a range of 0.6 g/ml to 0.85 g/ml. By way of further example, the superabsorbent polymer layer 153 can include a superabsorbent polymer having a retention absorbency of 41 g/g, an absorption capacity of 60 g/g (as measured in a 0.9% NaCl aqueous solution), an absorptive rate of 29 seconds, a moisture content of 7.4%, a measure of residual acrylic acid monomers of 22 ppm, and a bulk density of 0.74 g/ml. By way of still further example, the superabsorbent polymer layer 153 can include a superabsorbent polymer having a retention absorbency of 40 g/g, an absorption capacity of 60 g/g (as measured in a 0.9% NaCl aqueous solution), an absorptive rate of 30 seconds, a moisture content of 7.2%, a measure of residual acrylic acid monomers of 18 ppm, and a bulk density of 0.74 g/ml. Particle sizes of the superabsorbent polymer forming the superabsorbent polymer layer 153 may measure less than 850 microns (μm). For example, between 80% and 90% of the particles may have a particle size measuring in a range of 180 μm to 500 μm.

As further shown absorbent layer region 101 may further include a pulp layer 154. The pulp layer 154 may be formed by pulp fibers and/or pulp powder that is distributed within the layer as illustrated. This may then be followed by a tissue layer 155 which preferably comprises of tissue paper. This may then be followed by a bottom (continuous non-perforated barrier film) layer 156. The film layer 156 may be a polyolefin type film layer, such as a polyethylene film layer. In any case, film layer 156 is preferably formed from or includes an impermeable film that prevents the flow of waste fluid from contacting the floor or other surface 10 upon which the absorbent pad may be placed. As such, it should be understood that pad 100 has an upper (fluid permeable/absorption) side 140 which is to face the animal during use thereof, and a lower (fluid impermeable/barrier) side 150 which is to face the underlying surface during use.

Border region 103 is generally configured to indicate an end of absorbent region 101. Without limitation, in embodiments the border region 103 is preferably in the form of or includes a polyolefin film, such as but not limited to a polyethylene film. Without limitation, in embodiments border region 103 is part of a film layer of used in absorbent region 101, such as but not limited to a portion of film layer 156 that extends past the boundary of absorbent region 101. The material of border region 103 is flexible or pliable, such that it may be repositioned from a flat state to an upright state.

Pad 100 is depicted as preferably having an overall quadrilateral shape and as including a quadrilateral absorbent region 101 surrounded by border region 103. The pads described herein are not limited to such a configuration, and may have any suitable shape. For example, pad 100 may have an overall shape that has any suitable number of sides, such as 1, 2, 3, 4, 5, 6, 7, 8, 9, 10 or more sides. Likewise, absorbent region 101 may have any suitable number of sides, and in embodiments absorbent region 101 has a number of sides that is the same as or different from the number of sides of pad 100. Preferably, absorbent region 101 has the same number of sides as pad 100, wherein the sides of pad 100 are defined by outer edges of border region 103.

Pad 100 is also shown with an absorbent region 101 that includes four corners 125 (i.e., a first corner, second corner, third corner, and fourth corner). Such a configuration is not required, and absorbent region 101 may be configured differently. Indeed, absorbent region 101 may have any suitable geometry, with 0 or greater than 0 corners.

Each border region 103 may be adjacent to each side of absorbent region 101, and includes at least one inner and outer edge. For example, border region 103 includes a top outer edge 105, a top inner edge 107, a bottom outer edge 111, a bottom inner edge 113, a right outer edge 117, a right inner edge 119, a left outer edge 121, and left inner edge 123. Top and bottom inner edges 107, 113 extend laterally along corresponding top and bottom sides of absorbent region 101, and right and left inner edges 119, 123 extend vertically along corresponding right and left sides of absorbent region 101, respectively. In this embodiment the top, bottom, left, and right sides of absorbent region 101 extend between a respective two corners 125 of absorbent region 101.

As used herein, the term “inner edge” is used to describe a boundary between an edge of the absorbent region 101 and the border region 103. In embodiments each inner edge of border region 103 is defined by an edge of the material forming border region 103. In other embodiments, the border region is defined by part of a fluid impervious backing layer that extends past the edge of absorbent region 101. In such instances the inner edges of border region 103 are not defined by an end edge of the material forming border region 103, but rather are an interface at which the material of border region 103 is adjacent to the edges of absorbent region 101.

For the sake of illustration and ease of understanding, top outer edge 105, bottom outer edge 111, right outer edge 117, and left outer edge 121 have been illustrated as linearly extending substantially parallel to corresponding top inner edge 107, bottom inner edge 113, right inner edge 119, and left inner edge 123, respectively. Such a configuration is not required and outer edges 105, 111, 117, and 121 may have any suitable shape. In embodiments, outer edges 105, 111, 117, and 121 are preferably offset from inner edges 107, 113, 119, and 123, respectively, and a have a linear, curvilinear, stepped, or other shape.

Top outer edge 105 may be offset from top inner edge 107 by a first distance D1, bottom outer edge 111 may be offset from bottom inner edge 113 by a second distance D2, right outer edge 117 may be offset from right inner edge 119 by a third distance D3, and left outer edge 121 may be offset from left inner edge 123 by a fourth distance D4. D1-D4 may be defined as the linear distance between two opposing points on corresponding inner and outer edges, and may range from greater than 0 to about 3 inches, such as from greater than 0 to about 2.5 inches, or even from about 0.2 to about 2.3 inches. In embodiments D1, D2, D3, and D4 are each preferably in a range of about 0.2 to about 2.2 inches. In any case, D1-D4 may be the same or different from one another. Without limitation, D1, D2, D3, and D4 are the same or at least about the same.

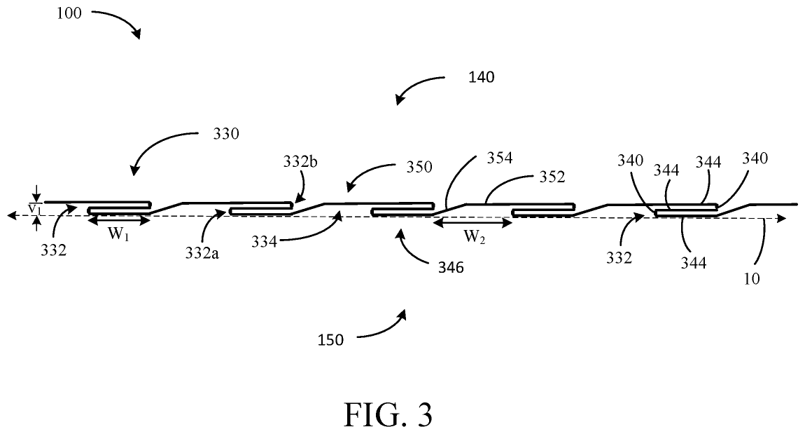

FIG. 3 provides a cross-sectional view of the bottom portion or layer of the pad of FIG. 1 along line A-A. As can be seen, the bottom portion, which may comprise one or more lower layers, which is preferably constructed of the polyethylene film layer 156 and tissue layer 155 (see FIG. 2) has one or a plurality of folded pleats 330. The upper layers (e.g., pulp layer 154, SAP layer 153, attractant layer 152 and top sheet layer 151) are not shown. The upper layers may or may not include the pleats 330. The pleats 330 may preferably include one or a plurality of stacked (on top of each other) folds 332 in the bottom portion of the pad 100. As illustrated, the pleats 330 include two folds 332, in which one of the folds 332b overlies the other fold 332a, but it can be appreciated that there may also be 3, 4, 5, 6, 7, 8, 9 or even 10 folds. According, the pleats 330 herein may have 1-10 folds 332. In addition, it can be appreciated that such folds 332 will therefore serve to elevate the upper layers of the pad (e.g., the pulp layer 154, SAP layer 153, attractant layer 152 and top sheet layer 151 from a floor surface. Preferably, the folds 332 therefore elevate the upper layers of the pad from the floor by a vertical height V₁ in the range of 0.05 mm to 2.00 mm, which may further be in a range of 0.10 mm to 2.0 mm, 0.50 mm to 2.0 mm, 0.75 mm to 2.0 mm, 1.0 mm to 2.0 mm, 0.05 mm to 1.5 mm, and 0.75 mm to 1.5 mm. The vertical height Vi may also be greater than or equal to 0.05 mm, 0.1 mm, 0.5 mm, 0.75 mm, 1.0 mm, 1.25 mm, 1.5mm and 1.75 mm. The pleats 330 themselves have a preferred width W₁ in the range of 5.0 mm to 30.0 mm, which may further be in a range of 5.0 mm to 25.0 mm, 5.0 mm to 20.0 mm, 5.0 to 15.0 mm, 5.0 to 10.0 mm, 10.0 mm to 30.0 mm, 10.0 mm to 25.0 mm, 10.0 mm to 20.0 mm, 10.0 mm to 15.0 mm, 15.0 mm to 30.0 mm, 15.0 mm to 25.0 mm, 15.0 mm to 20.0 mm, 20.0 mm to 30.0 mm, 20.0 mm to 25.0 mm, and 25.0 mm to 30.0 mm. The width W₁ may also be greater than 5.0 mm, 10.0 mm, 15.0 mm, 20.0 mm, 25.0 mm and 30.0 mm.

As shown, each fold 332 comprises a 180 degree fold bend 340, which may also be referred to as a fold line, disposed between and connecting adjacent, substantially parallel (e.g. within 10 degrees of being parallel), upper and lower fold segments 344 arranged in layered (stacked/overlying) relationship. As shown, fold 332b shares a fold segment 344 with fold 332a.

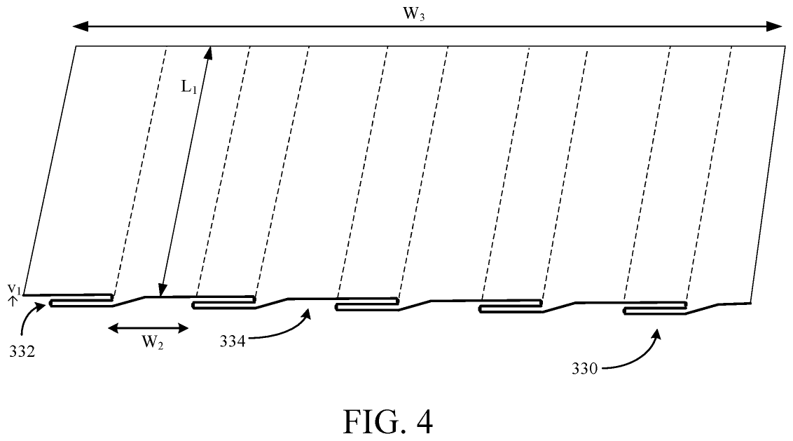

In addition, the folded pleats 330 are preferably spaced from one another by bridge region 350 having a width W₂, at least a portion of which is elevated relative to a base 346 of the pleats 330 As shown, the bridge region 350 connects between adjacent pleats 330, particularly the upper/uppermost fold segment 344 of the upper/uppermost fold 332b with the lower/lowermost fold segment 344 of the lower/lowermost fold 332a. The width W₂ may fall in the range of 1.0 mm to 650.0 mm, which can therefore vary depending upon the number of pleats 330 that may be present. For example, for a given pet training pad 100 having a width (W₃ in FIG. 4) of 1300 mm, there may only be two pleats 330, each extending about 325 mm from the edge, and therefore each spaced apart from one another by about 650 mm. Alternatively, the plurality of pleats 330 that are present may preferably be spaced at a distance W₂ of greater than or equal to, or less than or equal to 10.0 mm, 20.0 mm, 30.0 mm, 40.0 mm, 50.0 mm, 60.0 mm, 70.0 mm, 80.0 mm, 90.0 mm, 100.0 mm, 110.0 mm, 120.0 mm, 130.0 mm, 140.0 mm or 150.0 mm from one another. Thus, the distance W₂ may be in a range, for example, of any of two of the foregoing values (e.g. 10.0 mm to 150.0 mm, 10.0 mm to 30.0 mm, 70.0 mm to 140.0 mm, etc.).

In addition, even more preferably, the pleats 330 may be equally spaced from one another where equally spaced contemplates a variation of +/− 1.0 mm. By way of example, if the pleats 330 are to be evenly spaced from one another by 5.0 mm, it is contemplated that to evenly space the pleats 330, the pleats 330 may all be spaced 5.0 mm and +/− 1.0 mm. Finally, it is preferably that the pleats 330 are spaced from the border region 103 of the pad (FIG. 1) in the range of 1.0 mm to 10.0 mm.

Accordingly, between the pleats 330, particularly beneath the bridge regions 350, one then preferably forms one or a plurality of open channels 334 that provides one or a plurality of air gaps as between the bottom of the pad 100 and the floor. Such air gap has been observed to reduce or eliminate the condensation that may otherwise form between the bottom of the pad 100 and the floor surface. The open channels 334 therefore also then have the width W₂ noted above.

As shown, the bridge regions 350 may have a first bridge segment 352 which extends substantially parallel (e.g. within 10 degrees of being parallel) to the upper/uppermost fold segment 344 of the upper/uppermost fold 332b for at least a portion of the width W₂ of the bridge region 350. More particularly, the first bridge segment 352 may be at least 10%, 20%, 30%, 40%, 50%, 60%, 70%, 80%, or 90% of the width W₂ of the bridge region 350. The first bridge segment 352 may also have a width W₂ in a range of 10% to 90%, 10% to 80%, 10% to 70%, 10% to 60%, 10% to 50%, 10% to 40%, 20% to 90%, 20% to 80%, 20% to 70%, 20% to 60%, 20% to 50% or 20% to 40% of the width W₂ of the bridge region 350.

As shown, the bridge regions 350 may have a second bridge segment 354, which is at an obtuse angle relative to the first bridge segment 352. As shown, the second bridge segment 354 vertically transitions, preferably as a planar segment, from the upper/uppermost fold segment 344 of the upper/uppermost fold 332b to the lower/lowermost fold segment 344 of the lower/lowermost fold 332a.

FIG. 4 provides a perspective view of the bottom of the pad, where the upper layers have been eliminated, so that the spacing of the channels 334 can be more clearly observed. As noted, the channels themselves may preferably have a width W₂ in the range of 1.0 mm to 650 mm and a length L₁ in the range of 250 mm to 1200 mm that extends across the pad, which may further be in a range of 300 mm to 1100 mm, 350 mm to 1000 mm, 400 mm to 900 mm and 450 mm to 800 mm. It should also be appreciated that the pad 100 itself may preferably have a width W₃ in the range of 350 mm to 1300 mm, which may further include 400 mm to 1200 mm, 450 mm to 1100 mm, 500 mm to 1000 mm, 550 mm to 900 mm and 600 mm to 800 mm.

Accordingly, in broad context, the present disclosure relates to pet training pads 100 that can elevate from a given floor surface. Such elevation is preferably achieved by the presence of a bottom portion that includes one or more pleats 330 that contain one or more folds 332 which then operate to elevate the pad 100 from the floor and to define one or more channels 334 with air gaps that allow for air flow/venting. Such channels 334 therefore reduce or eliminate condensation that may otherwise collect on the bottom of the pad 100, between the pad bottom and a floor surface.

While the present disclosure has been described in detail for the preferred embodiments described above, it will be understood that modifications can be made without departing from the scope of the disclosure herein.

### LISTING OF REFERENCE CHARACTERS

10 selected surface
100 pad
101 absorbent layer region
103 border region
105 top outer edge
107 top inner edge
111 bottom outer edge
113 bottom inner edge
117 right outer edge
119 right inner edge
121 left outer edge
123 left inner edge
125 corner
140 fluid permeable/absorption side
150 fluid impermeable/barrier side
151 top layer
152 attractant layer
153 super absorbent polymer layer
154 pulp layer
155 tissue layer
156 bottom layer
330 pleat
332 fold
332a fold
332b fold
334 channel
340 fold bend
344 fold segment
346 base
350 bridge region
352 first bridge segment
D1 first distance
D2 second distance
D3 third distance
D4 fourth distance
L₁ bridge/channel length
V₁ vertical height
W₁pleat width
W₂ bridge/channel width
W₃ pad width

What is claimed:

1. A pet waste collection training pad arrangeable on a selected surface, comprising:
at least one upper layer and at least one lower layer;
the at least one upper layer containing absorbent; and
the at least one lower layer including at least one pleat having a base, wherein the at least one pleat elevates a region of the pad relative to the base of the pleat when the pad is on the selected surface.

2. The pad of claim 1 wherein the at least one lower layer comprises the bottom layer of the pad.

3. The pad of claim 2 wherein the bottom layer includes a channel which extends adjacent a longitudinal length of the at least one pleat, wherein the channel provides an air gap between the bottom layer of the pad and the selected surface when the pad is on the selected surface.

4. The pad of claim 2 wherein the bottom layer is a film layer.

5. The pad of claim 1 wherein the at least one pleat elevates the region of the pad relative to the base of the pleat by a vertical height in a range of 0.05 mm to 2 mm.

6. The pad of claim 1 wherein the at least one pleat elevates the region of the pad relative to the base of the pleat by a vertical height greater than or equal to 1 mm.

7. The pad of claim 1, wherein the at least one pleat includes at least one fold of the lower layer, wherein the fold comprises a fold bend connecting an upper fold segment overlying a lower fold segment.

8. The pad of claim 1, wherein the at least one pleat having the base further comprises a plurality of pleats each having the base, respectively;
the region of the pad is between the pleats; and
wherein each pleat of the plurality of pleats elevates the region of the pad between the pleats relative to the base of the pleats.

9. The pad of claim 8 wherein each pleat of the plurality of pleats elevates the region of the pad between the pleats relative to the base of the pleats by a vertical height in a range of 0.05 mm to 2 mm.

10. The pad of claim 8 wherein each pleat of the plurality of pleats elevates the region of the pad between the pleats relative to the base of the pleats by a vertical height greater than or equal to 1 mm.

11. The pad of claim 8 wherein each pleat of the plurality of pleats includes at least one fold of the lower layer, wherein the fold comprises a fold bend connecting an upper fold segment overlying a lower fold segment.

12. The pad of claim 8 wherein each pleat of the plurality of pleats includes at least first and second folds of the lower layer, wherein the second fold overlies the first fold.

13. The pad of claim 12 wherein the first and second folds each comprise a fold bend connecting an upper fold segment overlying a lower fold segment, respectively.

14. The pad of claim 13 wherein the upper fold segment of the first fold and the lower fold segment of the second fold is shared by the first and second folds.

15. The pad of claim 1 wherein the at least one pleat having the base further comprises a plurality of pleats each having the base, respectively;
a bridge is disposed between at least two pleats of the plurality of pleats, and
wherein at least a portion of the bridge is elevated relative to a base of the at least two pleats.

16. The pad of claim 15 wherein the bridge is elevated relative to a base of the at least two pleats by a vertical height in a range of 0.05 mm to 2 mm.

17. The pad of claim 15 wherein the bridge is elevated relative to a base of the at least two pleats by a vertical height greater than or equal to 1 mm.

18. The pad of claim 15 wherein the bridge is disposed between at least one fold of a first pleat of the two pleats and at least one fold of a second pleat of the two pleats.

19. The pad of claim 15 wherein the first pleat and the second pleat each comprise a lower fold and an upper fold; and
wherein the bridge connects the upper fold of the first pleat to the lower fold of the second pleat.

20. A pet waste collection training pad arrangeable on a selected surface, comprising:
an upper layer including absorbent; and
a bottom layer including a channel which extends adjacent a longitudinal length of at least one pleat in the bottom layer, wherein the channel provides an air gap between the bottom layer of the pad and the selected surface when the pad is disposed on the selected surface;
wherein the channel has a vertical height relative to a base of the pleat in a range of 0.05 mm to 2 mm;
wherein the channel has a width W₁ in the range of 5 mm to 30 mm and a length in the range of 250 mm to 1200 mm.
